(19) United States
(12) Patent Application Publication
(10) Pub. No.: US 2022/0174873 A1
(43) Pub. Date: Jun. 9, 2022

(54) COMBINE AND METHOD FOR OPERATING A COMBINE

(71) Applicant: CLAAS Selbstfahrende Erntemaschinen GmbH, Harsewinkel (DE)

(72) Inventors: Philipp Topmöller, Herzebrock-Clarholz (DE); Andreas Brand, Marienfeld (DE); Christian Beulke, Echte (DE); Manuel Elpmann, Salzkotten (DE); Jens Bußmann, Ostercappeln (DE)

(73) Assignee: CLAAS Selbstfahrende Erntemaschinen GmbH, Harsewinkel (DE)

(21) Appl. No.: 17/542,608

(22) Filed: Dec. 6, 2021

(30) Foreign Application Priority Data
Dec. 7, 2020 (DE) 102020132401.4

(51) Int. Cl. A01D 41/127; A01D 41/12; A01F 7/06; A01F 12/40

(52) U.S. Cl. CPC A01D 41/1271; A01F 12/40; A01F 7/067; A01D 41/1243

(57) ABSTRACT

A self-propelling combine and a method for operating a self-propelling combine are disclosed. The combine includes an axial spreader, which generates a residual flow of material and supplies the residual flow of material to a downstream distribution device that discharges the residual flow of material from the combine. The axial separator in the end-side material delivery region has at least one guide element that may be moved by an actuator, thereby affecting a distribution of the exiting residual flow of material over the supply width of the distribution device. The distribution of the residual flow of material is detected by at least one sensor unit, and when a deviation from a target distribution is detected, the guide element is adjusted. A control device receives and uses a signal representing a side wind used to automatically adjust of the at least one guide element.

### CROSS REFERENCE TO RELATED APPLICATION

This application claims priority under 35 U.S.C. § 119 to German Patent Application No. DE 102020132401.4 filed Dec. 7, 2020, the entire disclosure of which is hereby incorporated by reference herein.

### TECHNICAL FIELD

The present invention relates to a method for operating a self-propelling combine and a self-propelling combine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

US Patent Application Publication No. 2020/0305352, which is incorporated by reference herein in its entirety, discloses a self-propelling combine that detects a given distribution of a residual flow of material generated by an axial separator to a downstream distribution device, and in which a guide element in the end-side material delivery region of the axial separator is shifted in order for the axial distribution to approach a target distribution. Sensor units for detecting the residual flow of material may be provided at various points before the distribution device in order to detect the distribution of the residual flow of material over the supply width of the distribution device.

The residual flow of material, which may substantially consist of straw components, is transferred by the axial separator to a downstream working unit of the combine, such as to a chopping device, wherein the residual flow of material is distributed using at least one movable guide element over a supply width of the chopping device. The residual flow of material is processed by the chopping device, such as comminuted or chopped. Such processing by the chopping device may be important when the residual flow of material delivered by the distribution device from the combine is not to be further utilized (e.g., not to be picked up from the field and supplied for another purpose). The comminution of the residual flow of material may be advantageous in order to accelerate biological decomposition and the return of nutrients to the soil of the field associated therewith.

In actuating the guide element, US Patent Application Publication No. 2020/0305352 discloses considering the distribution of material after delivering the residual flow of material in the end-side material delivery region of the axial separator in order to achieve a very even distribution by the distribution device while discharging from the combine.

### DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates a cross-section of a combine;

FIG. 2 schematically illustrates a transitional region between an axial separator and a chopping device of the combine from FIG. 1;

FIG. 3 schematically illustrates a transitional region between the axial separator and the chopping device of the combine from FIG. 2 with a distribution device designed as a deflector distributor; and

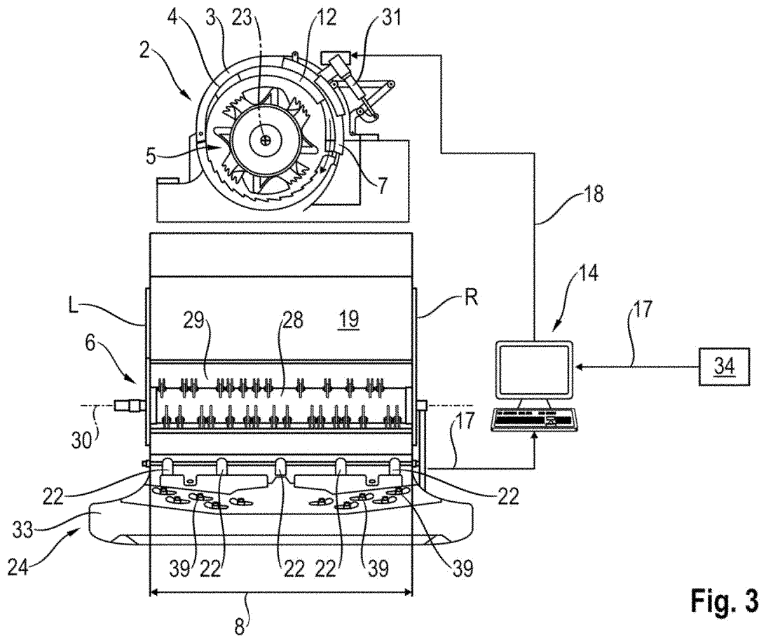

FIG. 4 illustrates a perspective partial view of the rear region of the combine, as well as a detail view of a sensor apparatus for detecting side wind.

### DETAILED DESCRIPTION

In one or some embodiments, a combine and a method for operating a combine is disclosed which considers or takes into account external influences when actuating the guide element (e.g., whether and/or how to actuate the guide element). Thus, one object is to disclose a method for operating a self-propelling combine, and a self-propelling combine of the aforementioned type, to achieve improved distribution of the flow of residual material on a field.

In one or some embodiments, a method is disclosed for operating a self-propelling combine, wherein a residual flow of material generated by an axial separator is supplied to a downstream distribution device that discharges the residual flow of material from the combine, wherein the axial separator in the end-side material delivery region has at least one guide element that may be moved by an actuator, which may modify at least a part or all of the exiting residual flow of material (e.g., modifying a given distribution of the exiting residual flow of material) over the supply width of the distribution device, wherein the given distribution of the residual flow of material may be detected by at least one sensor unit, and when a deviation from a given target distribution is detected, the guide element may be adjusted. To achieve the above-disclosed object, at least one signal representing or indicative of a side wind is provided to control device (e.g., the at least one signal may be generated by at least one sensor and transmitted to the control device). The control device may use the at least one signal as a disturbance variable in the automatic adjustment of the at least one guide element (e.g., the control device may adjust the at least one guide element based on the at least on signal indicative of the side wind). In this way, the influence or effect of side wind may be considered as an external influential variable on the distribution of the residual flow of material (e.g., the evenness of the distribution of the residual flow of material) by the distribution device on the field. In one or some embodiments, the term “side wind” may be understood as an airflow directed at an angle to the driving direction of the combine, wherein the angle is different than 0°. In particular, the distribution device may be designed as a deflector distributor. The method according to one aspect may be advantageous for a distribution device designed as a deflector distributor since the discharging of the residual material onto the soil of the field may only be influenced slightly in contrast to a distribution device designed as an actively driven power spreader to compensate for the influence of side wind.

In one or some embodiments, the control device may continuously receive a signal from an external signal source, such as from an anemometer set up or positioned at the edge of the field, or from an external service provider. Alternatively or in addition, at least two sensor apparatuses may be arranged as signal sources opposite each other on the outside of the combine, through which the occurrence of side wind is detected, and the signals representing or indicative of the side wind are generated indicative of a value of the detected side wind.

In one or some embodiments, a predetermined distribution, such as a balanced distribution ratio over the supply width of the distribution device, may be specified as a target distribution. To accomplish this, the control device may be connected to or in communication with an input/output unit of the combine that enables a user of the combine (such as an operator) to specify a particular specified value for the target distribution. In one or some embodiments, the specified target distribution (provided by the user) may provide a balanced distribution ratio, according to which the residual flow of material is basically divided in half so that the distribution device may be basically fed equal parts of the residual flow of material over its supply width. A situation on the field is contemplated that may necessitate a different distribution of the residual flow of material supplied by the axial separator over the supply width. This may, for example, be the case when the distance of the combine to a field edge is less than the set proportionate distribution width according to the target distribution relative to a longitudinal axis of the combine. Using the at least one sensor unit, a given distribution that deviates from this target distribution may be detected and forwarded to the control device. Alternatively, the at least one sensor unit may send (such as periodically send) data indicative of the given distribution, with the control device determining whether the given distribution deviates from the target distribution. In turn, the control device may be configured to generate control signals (e.g., control commands) depending on the identified deviation of the given distribution from the target distribution, and to transmit these control signals (e.g., control commands) to the actuator of the at least one guide element (thereby modifying the given distribution). In this way, the guide element may be adjusted such that the given distribution at least approaches the target distribution. And as a result, there is feedback between an actual given distribution of the residual flow of material and the specified target distribution of the residual flow of material to the working unit. In one or some embodiments, the feedback may be continuous. In the context of this feedback, the side wind detected by the sensor apparatus may also be considered as a disturbance variable. In so doing, the specified target distribution may be adapted or modified, such as continuously adapted or modified, based on the influence of the side wind.

In one or some embodiments, to determine the influence of the side wind on the distribution, the wind strength and wind direction may be detected independently of each other using at least two sensor apparatuses. In this way, effects such as partial shading by the combine itself may be compensated. Moreover, this may improve the measuring accuracy.

In particular, the two sensor apparatuses may be arranged or positioned in a common horizontal plane on the combine, but at different portions of the combine, such as at opposite sides of the combine in the same horizontal plane. When there is alternating wind shading of one of the two wind measuring apparatuses by the combine itself, for example after driving on a headland, the same measuring conditions may be maintained (such as always maintained) independent of which of the two measuring devices is shaded by the combine since in general, at least one of the two measuring devices may be located on the side of the combine facing the wind.

Moreover, signals for wind strength and wind direction generated by the at least two sensor apparatuses may be compared with each other, wherein the signal from the sensor with the greater (or greatest) signal strength is taken into account at least partly to compensate for the influence of the side wind when actuating the actuator. For example, the at least two sensor apparatuses may comprise a first sensor apparatus configured to generate one or more first sensor outputs (e.g., one or both of the wind strength and wind direction) and a second sensor apparatus configured to generate one or more second sensor outputs (e.g., one or both of the wind strength and wind direction). The control device may compare the one or more first sensor outputs from the first sensor apparatus with the one or more second sensor outputs from the second sensor apparatus. The comparison by the control device of the one or more first outputs and the one or more second outputs may be used by the control device to determine which of the first sensor apparatus or the second sensor apparatus are sensing greater side wind. In turn, the control device may automatically change at least one aspect of the at least one guide element (e.g., adjust the position of the at least one guide element) using the respective one or more outputs of the first sensor apparatus or the second sensor apparatus that is sensing the greater side wind. Consequently, when there is at least partial shading of one of the two wind measuring devices by the combine, a signal representing the actual side wind conditions may be provided to the control device to use as a disturbance variable when generating the control commands to actuate the actuator, in addition to the deviation between the given distribution and target distribution.

In one or some embodiments, one or more variables may be modified in order for the given distribution to approach the target distribution. As one example, a speed of movement of the at least one guide element may be changed (such as continuously changed) in order for the given distribution to approach the target distribution. This may allow a distribution of the residual flow of material transferred by the axial separator to the chopping device to be changed before the chopping device supplies the comminuted residual flow of material to the distribution device.

In one or some embodiments, a self-propelling combine is disclosed that comprises an axial separator configured to generate a residual flow of material and to supply the residual flow to a distributor device that is downstream from the axial separator and which is configured to discharge the residual flow of material from the combine. The axial separator in the end-side material delivery region may have at least one guide element that may be moved by an actuator, which may influence a given distribution of the exiting residual flow of material over the supply width of the distribution device. The self-propelling combine may include at least one sensor (such as at least two sensors) configured to detect the axial distribution of the residual flow of material (e.g., the at least one sensor configured to generate at least one signal indicative of a side wind), and a control device configured to: receive the at least one signal indicative of a side wind from at least one signal source; and use the at least one signal (e.g., use the at least one signal as a disturbance variable) to adjust the at least one guide element. In particular, the control device is configured to determine a deviation of the distribution of the residual flow of material from a given target distribution and, depending on the deviation, to actuate the actuator to adjust the at least one guide element. In one or some embodiments, the distribution device is designed as a deflector distributor.

In a particular embodiment, at least two sensor apparatuses may be arranged or positioned as signal sources opposite each other on the outside of the combine, with the at least two sensor apparatuses being configured to detect the occurrence of side wind (e.g., generate one or more indications of the side wind). The control device may be configured to evaluate the signals of the sensor apparatuses and use them as a disturbance variable in the automatic adjustment of the guide element.

In one or some embodiments, the at least two sensor apparatuses are arranged or positioned above the distribution device and below the material delivery region of the axial separator. Accordingly, the at least two sensor apparatuses may be less inclined for the sensor readings generated by the at least two sensor apparatuses to be influenced by contaminants. Moreover, this arrangement may better detect the wind flow conditions that are attributable to the side wind.

In particular, the signal sources formed by at least two sensor apparatuses may be arranged or positioned opposite each other and may be designed as a wind plate, an impeller anemometer or a cup anemometer. The design of the at least two sensor apparatuses as mechanical sensor apparatuses is straightforward and economical. For example, a combine may be easily retrofitted with the at least two sensor apparatuses by positioning the at least two sensor apparatuses above the distribution device and below the material delivery region of the axial separator.

Moreover, the at least one sensor unit for determining the given distribution may be arranged at at least one measuring point in the supply region of a chopping device downstream from the axial separator, and/or on a floor sectionally enclosing a cutter drum of the downstream chopping device. By arranging the at least one sensor unit in the supply region of the chopping device, the distribution of the residual flow of material may be detected generally over at least a part, such as over the width (e.g., the entire width), of the chopping device. By the alternative or additional arrangement of the at least one sensor unit on the floor of the chopping device, the distribution of the residual flow of material may also be detected within the chopping device. In particular, the combination of both arrangements of the sensor units may be advantageous so that a distribution of the residual flow of material may be dynamically tracked substantially over the width (such as over nearly all or entirely all) of the chopping device. In particular, migrations of the residual flow of material may occur in the direction of the width of the chopping device that arise from the operation of the chopping device that might not be able to be considered when only detecting data relating to the given distribution of the residual flow of material, for example in the supply region of the chopping device.

In one or some embodiments, the at least one sensor unit may be designed as a measuring strip, wherein the at least one sensor unit has a plurality of sensor elements at a distance from each other. Specifically, such a measuring strip comprises a plurality of sensor elements at a distance from each other that may be distributed equidistantly along the measuring strip. In particular, it is contemplated that the sensor unit is designed as a measuring strip that extends over a width of a particular monitored region so that a cross-distribution of the residual flow of material is detectable in the particular monitored region. With a measuring strip positioned, for example, in the supply region of the chopping device, the measuring strip may extend over or substantially over the width of the chopping device, wherein a plurality, such as at least five, sensor elements are arranged or positioned distributed over the length of the measuring strip. Data detected in this way are particularly suitable for evaluating the given distribution of the residual flow of material.

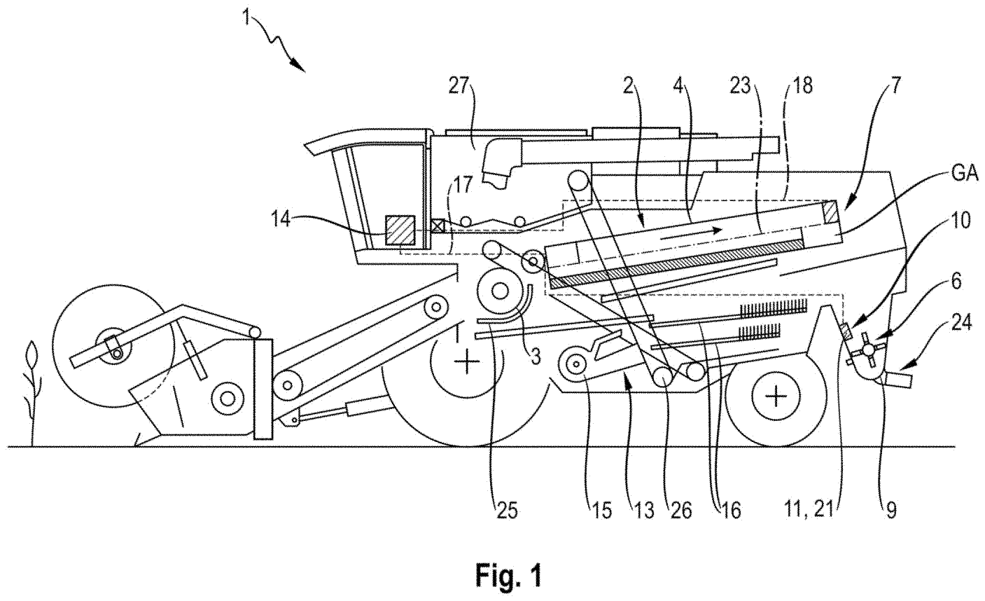

Referring to the figures, FIG. 1 illustrates a cross-section of a self-propelling combine 1. The combine 1 comprises a threshing device 3 that is downstream from an axial separator 2. The threshing device 3 is configured to transfer a flow of harvested material to the axial separator 2. Harvested plants are processed by the threshing device 3 so that grains from remaining plant residues, such as chaff and straw, are removed. A majority of the grains is supplied through at least one threshing concave 25 directly to a grain pan arranged below the at least one threshing concave 25. From the grain pan, the grains pass to a cleaning device 13 that comprises a fan 15 and a plurality of sieves 16. The cleaning device 13 separates short straw components and chaff from the grain.

Then, the cleaned grains are guided in the direction of a conveying apparatus 26 by which the grains are conveyed into a grain tank 27. The remaining plant residues are transferred to the axial separator 2 together with the remaining grains that could not be directly separated by the threshing device 3. Together, the remaining grains and plant residues also form the flow of harvested material supplied to the axial separator 2 for further processing. The axial separator 2 serves to separate the grains contained in the transferred flow of harvested material from the plant residues to obtain as much grain as possible. The flow of harvested material is converted into a residual flow of harvested material by the axial separator 2 as a result of removing the part of the material formed by the grains. The latter substantially consists of plant residues that will be termed residual material.

The grains are separated by the axial separator 2 using at least one axial rotor 5 that is rotatably driven about its longitudinal axis 23 and is mounted within a housing 4 of the axial separator 2. The axial separator 2 may have a single axial rotor 5 or at least two axial rotors 5 arranged parallel to each other and such that each are arranged in a separate housing 4.

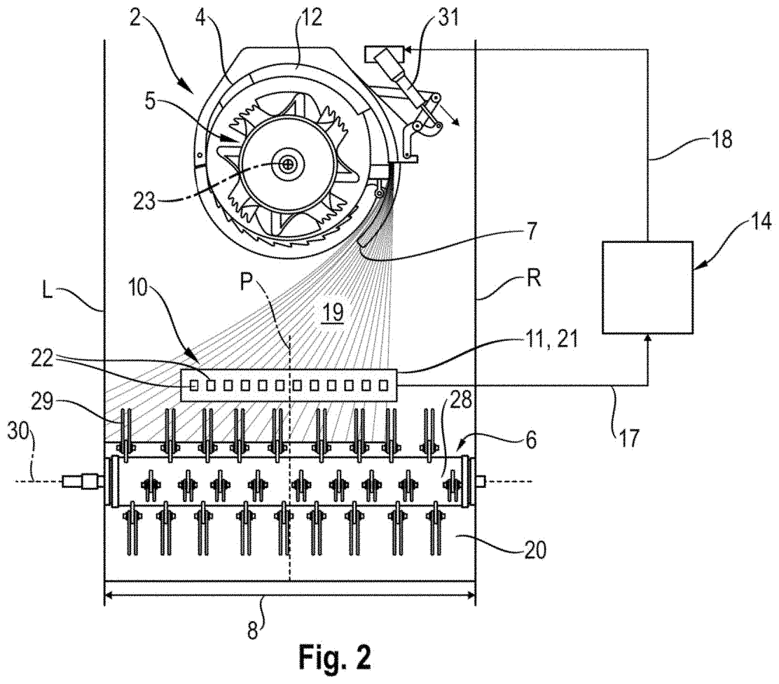

At a rear, end-side material delivery region GA of the axial separator 2 facing away from the threshing device 3, the axial separator 2 comprises at least one guide element 7 that may be formed by a guide plate, which may be curved in design with the curvature corresponding to a curvature of the housing 4. The at least one guide element 7 is designed movable relative to the housing 4 and, for this purpose, acts in concert with the electrohydraulic actuator 31, through which the guide element 7 may be driven, as shown in FIG. 2. In the instance where the axial separator 2 has two axial rotors 5, each axial rotor 5 may include a housing 4 with a guide element 7 arranged or positioned in the material delivery region GA, and an actuator 31.

Instead of the separate threshing device 3 designed as a tangential threshing unit, the threshing device may be designed together with the axial separator as a combination of an axial threshing rotor and axial separation rotor.

The guide element 7 may be moved sectionally using the actuator 31 in the circumferential direction of the housing 4. The residual flow of material leaving the axial separator 2, that is guided in a spiral or helix within the housing 4 using guide elements 12, primarily exits the adjacent material delivery region GA of the housing 4. The guide element 7 is assigned to this material delivery region GA so that the guide element 7 may influence or affect a flow of the residual flow of material. In particular, the guide element 7 enters a region of the residual flow of material such that the residual flow of material, upon leaving the axial separator 2, may strike the guide element 7 and be deflected thereby. By moving the guide element 7 relative to the housing 4, the guide element 7 may change the type or intensity of the deflection of the residual flow of material. As a consequence, the residual flow of material may be transferred in different ways to a working unit downstream from the axial separator 2 depending on a position of the guide element 7. In this regard, moving of the guide element 7 may change at least one aspect (e.g., type and/or intensity of deflection) of the residual flow of material. The working element may be designed as a chopping device 6.

In one or some embodiments, the chopping device 6 is arranged vertically below the axial separator 2 so that the residual flow of material discharged from the axial separator 2 in the material delivery region falls into the chopping device 6. The chopping device 6 has an elongated cutter drum 28 on the outer lateral surface of which a plurality of chopping blades 29 are arranged overhung. The plurality of chopping blades 29 are articulated (e.g., connected by hinges or joints) to the cutter drum 28 such that they are flung radially outward during a rotation of the cutter drum 28 around a drive shaft 30 of the chopping device 6 due to acting centrifugal forces. The kinetic energy acting during the rotation of the cutter drum 28 may be used to comminute the residual flow of material falling into the chopping device 6 using the cutting blades 29. The cutter drum 28 of the chopping device 6 may extend over a width 8 that basically constitutes the working width of the chopping device 6. Using the guide element 7, the residual flow of material may be distributed over the width 8 of the chopping device 6 so that the chopping device 6 is supplied very evenly with the residual flow of material over its width 8. As a consequence, chopped residual material may be passed on to a downstream distribution device 9 in a distribution of more or less equal parts, whereby an even ejection of the residual material at the rear end of the combine 1 may in turn result.

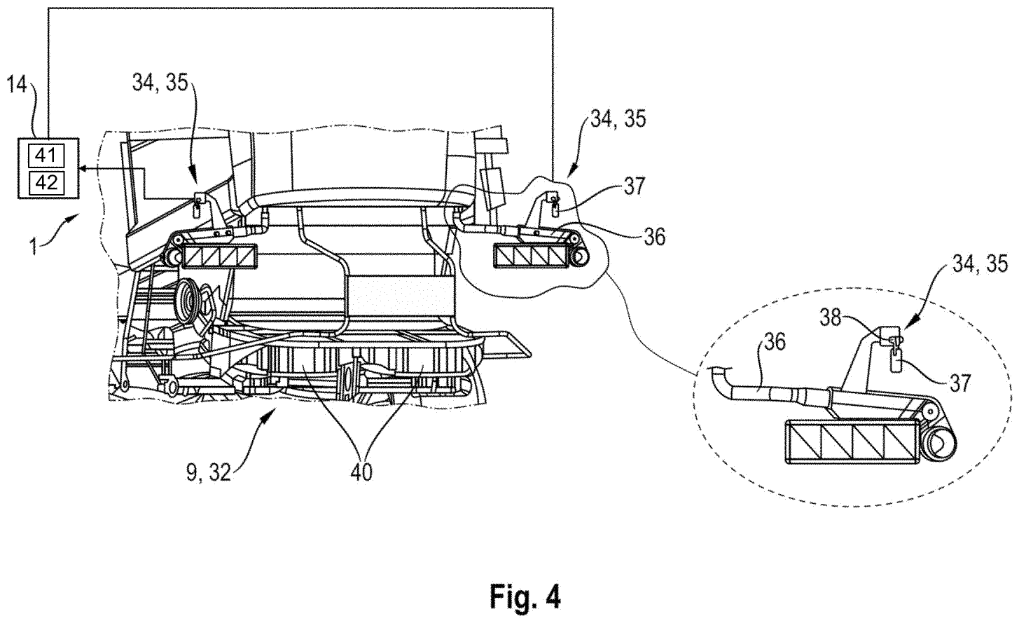

The distribution device 9 may be designed as an actively driven power spreader 32, as shown for example in FIG. 4. In one or some embodiments, the distribution device 9 is designed as a deflector distributor 24. The distribution device 9 designed as a deflector distributor 24 comprises a cover component 33, on the bottom side of which distribution plates are arranged (not shown). The distribution plates are each arranged pivotably about a vertical axis on a cover component 18. In the interior of the cover component 18, actuation means 39 are arranged by which the distribution plates are pivotable individually and/or in groups about the particular vertical axis. Such a deflector distributor is disclosed in DE102018131432 A1, incorporated by reference herein in its entirety.

Relative to a plane of symmetry P of the chopping device 6, the distribution plates, which may be arranged to the left and right of the plane of symmetry P, have opposing curvatures so that, proceeding from the middle of the distribution device 9 designed as a deflector distributor 24, the residual material may be distributed basically over the working width of the combine 1. The kinetic energy produced by the chopping device 6 while chopping may be used to distribute the residual material. Since the one or more actuating means of the deflector distributor 24 may only influence or affect the deflection of the flow of residual material by the distribution plates, but not the kinetic energy by which the residual material is discharged, the influence or effect of the side wind on the distribution by the deflector distributor 24 may be much higher than with a distribution device 9 designed as an actively driven power spreader.

As a consequence, the position of the guide element 7 on the axial separator 2 may have an indirect influence on the way in which the residual material, while it is being ejected from the combine 1, is distributed on the field by the distribution device 9 designed as a deflector distributor 24. A change in the position of the guide element 7 relative to the housing 4 of the axial separator 2 may consequently also cause the distribution of the residual material onto the field to change.

Using at least one sensor unit 10 that is arranged or positioned at a measuring point 11 in the supply region and/or feeding region 19 of the chopping device 6, it may be determined that, relative to the axis of symmetry P, the left side L of the chopping device 6 is receiving a greater portion of the residual flow of material transferred by the axial separator 2 than the right side R. The at least one sensor unit 10 may be designed as a measuring strip 21 and may comprise a plurality of sensor elements 22 spaced at a predetermined distance from each other (e.g., such that plurality of sensor elements 22 are positioned equidistantly along the measuring strip 21). In particular, it may be advantageous for the sensor unit 10, designed as a measuring strip 21, to extend over the width of each monitored region, such as over the width of the feed region 19, so that a cross-distribution of the residual flow is detectable in each monitored region. When the measuring strip 21 is arranged or positioned in the feed region 19 of the chopping device 6, the measuring strip 21 extends or substantially extends over the width 8 of the chopping device 6. Moreover, the at least one sensor unit 10 for determining the given distribution may be arranged or positioned at at least one measuring point on the floor 20 sectionally enclosing the cutter drum 28 of the downstream chopping device 6. By arranging the at least one sensor unit 10 in the supply region or feed region 19 of the chopping device 6, the distribution of the residual flow of material may be detected, such as generally over the width 8 of the chopping device 6. By the alternative or additional arrangement of the at least one sensor unit 10 on the floor 20 of the chopping device 6, the distribution of the residual flow of material may also be detected within the chopping device 6. In particular, the combination of both arrangements of the sensor units 10 (e.g., in the supply region or feed region 19 of the chopping device 6 and on the floor 20 of the chopping device 6) may be advantageous so that a distribution of the residual flow of material may be dynamically tracked over or substantially over the width 8 of the chopping device 6.

The uneven discharge of the residual flow of material transferred from the axial separator 2 may cause the given distribution of the residual flow of material to be asymmetrical even when exiting the chopping device 6, and the transfer to the distribution device 9 may in turn therefore be asymmetrical. The latter may influence the evenness of the discharge by the distribution device 9. The predetermined target distribution, however, may necessitate an even distribution of the residual flow of material to the distribution device 9 to achieve a very homogenous distribution of the residual material on the field. In one or some embodiments, the control device 14 may be configured to determine the difference between the given distribution and the target distribution. In response to the control device 14 determining that the difference between the given distribution and the target distribution is greater than a predetermined amount, the control device 14 may transmit a control command to the actuator 31 of the guide element 7, with the control command indicative to the guide element 7 to move. In response to receipt of the control command, the guide element 7 is consequently moved. In one example, this movement of the guide element 7 is such that the deflection caused by the guide element 7 and the resulting distribution of the residual flow of material to the chopping device 6 is changed in that the right side R of the chopping device 6 is fed a greater portion of the residual flow of material than before. As an indirect consequence of this intervention, the given distribution of the residual flow of material may approach or may reduce the difference from the target distribution.

In one or some embodiments, the guide element 7 is moved (e.g., continuously) relative to the housing 4 of the axial separator 2 in order to distribute (such as continuously distribute) the residual flow of material over the width 8 of the chopping device 6. In particular, the guide element 7 may execute an “oscillating” movement during which the guide element 7 is continuously moved between opposing extreme positions. An oscillating movement of the guide element 7 may also be very useful in order to evenly supply the chopping device 6 continuously with residual material over its entire width 8 and thereby achieve a corresponding feeding of the distribution device 9 in equal amounts.

FIG. 4 shows a perspective partial view of the rear region of the combine 1, as well as a detailed view of a sensor apparatus 34 for detecting side wind. In this shown embodiment, the distribution device 9 is only designed as a power spreader 32 that has rotors 40 arranged in pairs. The rotors 40 are driven to rotate in the opposite direction. The rotors 40 may be driven hydraulically or mechanically.

Arranged as signal sources above the distribution device 9 are at least two sensor apparatuses 34 for providing at least one signal representing a side wind (e.g., each sensor apparatus generates the at least one signal indicative of the side wind). In one or some embodiments, the at least two sensor apparatuses 34 are arranged or positioned above the distribution device 9 (e.g., deflector distributor 240 and below the material delivery region GA of the axial separator 2. Accordingly, the at least two sensor apparatuses 34 may be exposed to the influence of contaminants to a lesser extent. Therefore, the at least two sensor apparatuses 34 may primarily detect the wind flow conditions in the region of the distribution device 9 that are attributable to the side wind.

The at least two sensor apparatuses 34, arranged or positioned opposite each other, may be designed as wind plates 35. Alternatively, the sensor apparatuses 34 may comprise impeller anemometers or cup anemometers.

The sensor apparatuses 34, designed as wind plates 35, may be arranged or positioned on swinging arms 36 that are attached to both sides of the combine 1. In one or some embodiments, the wind plates 35 each have a plate-shaped element 37 that is pivotable about a horizontal pivot axis. The pivot axis is oriented parallel or substantially parallel to the driving directions so that the airstream has almost no influence on measurement. The deflection caused by the side wind of the particular plate-shaped element 37 may be detected by an angle sensor 38. The angle sensors 38 may transmit their signals by wire or wirelessly to the control device 14 for evaluation.

Since the side wind may influence the distribution of the flow of residual material discharged onto the field by the distribution device 9, the signals of the sensor apparatuses 34 are transmitted to the control device 14 and evaluated thereby. At least one signal representing the side wind is provided by the sensor apparatuses 34 as a signal source to the control device 14, and is used by the control device 14 as a disturbance variable in the automatic adjustment of the guide element 7.

Control device 14 may comprise any type of computing functionality and may include at least one processor and at least one memory, which is depicted in FIG. 4 as processor 41 (which may comprise a microprocessor, controller, PLA, or the like) and memory 42. Though the processor 41 and memory 42 are depicted as separate elements, they may be part of a single machine, which includes a microprocessor (or other type of controller) and a memory.

The processor 41 and memory 42 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Control device 14 may be configured to receive one or more signals indicative of the residual flow of material (e.g., from sensor unit 10) and/or indicative of the side wind (e.g., from sensor apparatus 34). The received signals may be stored in a memory, such as memory 42. Further, the control device 14 may be configured, using processor 41, to compare the distribution of the residual flow of material with a predetermined distribution, such as a balanced distribution ratio over the supply width of the distribution device to determine a difference between the two. Further, the control device may determine an amount of side wind (which may comprise or may be used to generate a disturbance variable). Based on one or both of the difference and the disturbance variable, the control device 14 may generate a command and transmit the command to the actuator 31 of the at least one guide element 7 in order to adjust the position of the at least one guide element 7 (and in turn modify the distribution of the residual flow of material).

By additionally taking into account the side wind arising while discharging in the adjustment of the guide element 7, a compensation of the influence of the side wind on the distribution may be achieved at an early point in time before the residual material reaches the distribution device 9. Accordingly, the distribution of the residual material, in particular by the distribution device 9 designed as a deflector distributor 24, may be more homogeneous on the soil of the field.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

| | |
|---|---|
| 1 | Combine |
| 2 | Axial separator |
| 3 | Threshing device |
| 4 | Housing |
| 5 | Axial rotor |
| 6 | Chopping device |
| 7 | Guide element |
| 8 | Width |
| 9 | Distribution device |
| 10 | Sensor unit |
| 11 | Measuring point |
| 12 | Guide element |
| 13 | Cleaning device |
| 14 | Control device |
| 15 | Fan |
| 16 | Sieve |
| 17 | Line |
| 18 | Line |
| 19 | Feed region |
| 20 | Floor |
| 21 | Measuring strip |
| 22 | Sensor element |
| 23 | Longitudinal axis |
| 24 | Deflector distributor |
| 25 | Threshing concave |
| 26 | Conveyor unit |
| 27 | Grain tank |
| 28 | Cutter drum |
| 29 | Cutting blade |
| 30 | Drive axle |
| 31 | Actuator |
| 32 | Power spreader |
| 33 | Cover component |
| 34 | Sensor apparatus |
| 35 | Wind plate |
| 36 | Swinging arm |
| 37 | Plate-shaped element |
| 38 | Angle sensor |
| 39 | Actuating means |
| 40 | Rotor |
| 41 | Processor |
| 42 | Memory |
| GA | Material discharging region |
| P | Axis of symmetry |
| L | Left side of page of 6 |
| R | Right side of page of 6 |

1. A method for operating a self-propelling combine, the method comprising:
generating, by an axial separator, a residual flow of material, wherein the axial separator in an end-side material delivery region has at least one guide element configured to be moved by an actuator, wherein movement of the at least one guide element modifies a distribution of the residual flow of material;
supplying the residual flow of material to a downstream distribution device that discharges the residual flow of material from the combine;
detecting, by at least one sensor unit, the distribution of the residual flow of material;
detecting, using one or more sensor apparatuses, an indication of a side wind, the side wind comprising an airflow directed at an angle to a driving direction of the combine; and
automatically adjusting, based on the indication of the side wind, a position of the at least one guide element, thereby modifying the distribution of the residual flow of material.

2. The method of claim 1, further comprising detecting a difference between the distribution of the residual flow of material and a target distribution;
wherein the indication of the side wind is interpreted by a control device as a disturbance variable; and
wherein automatically adjusting the position of the at least one guide element is based on the disturbance variable and the difference between the distribution of the residual flow and the target distribution.

3. The method of claim 1, wherein a balanced distribution ratio is specified over a supply width of the distribution device; and
wherein automatically adjusting the position of the at least one guide element is further based on the balanced distribution ratio.

4. The method of claim 2, wherein the one or more sensor apparatuses are positioned on the combine; and
wherein the one or more sensor apparatuses sense indications of both wind strength and wind direction.

5. The method of claim 4, wherein the one or more sensor apparatuses sense the indications of the wind strength and the wind direction independently of one another.

6. The method of claim 5, wherein the one or more sensor apparatuses comprise a first sensor apparatus configured to generate one or more first outputs and a second sensor apparatus configured to generate one or more second outputs;
wherein the one or more first outputs are compared with the one or more second outputs; and
wherein automatically adjusting the position of the at least one guide element is based on the comparison of the one or more first outputs and the one or more second outputs.

7. The method of claim 6, wherein the comparison of the one or more first outputs and the one or more second outputs is used to determine which of the first sensor apparatus or the second sensor apparatus are sensing greater side wind; and
wherein automatically adjusting the position of the at least one guide element uses respective one or more outputs of the first sensor apparatus or the second sensor apparatus that is sensing the greater side wind.

8. The method of claim 7, wherein the first sensor apparatus and the second sensor apparatus are positioned at opposite sides of the combine in a same horizontal plane.

9. The method of claim 1, wherein, for the distribution of the residual flow of material to approach a target distribution, a speed of movement of the at least one guide element is changed.

10. The method of claim 9, wherein the speed of movement of the at least one guide element is continuously changed in order for the distribution of the residual flow of material to approach the target distribution.

11. A self-propelling combine comprising:
an axial separator configured to generate a residual flow of material and to supply the residual flow of material to a distributor device, wherein the axial separator in an end-side material delivery region has at least one guide element configured to be moved by an actuator and in which movement of the at least one guide element modifies a distribution of the residual flow of material;
the distributor device downstream from the axial separator and configured to discharge the residual flow of material from the combine;
at least one sensor unit configured to detect the distribution of the residual flow of material;
one or more sensor apparatuses configured to generate an indication of a side wind, the side wind comprising an airflow directed at an angle to a driving direction of the combine; and
a control device configured to:
receive the indication of the side wind from the one or more sensor apparatus; and
generate, based on the indication of the side wind, one or more control signals to control the actuator to automatically adjust a position of the at least one guide element in order to modify the distribution of the residual flow of material.

12. The combine of claim 11, wherein a balanced distribution ratio is specified over a supply width of the distribution device; and
wherein the control device is configured to generate the one or more control signals to automatically adjust the position of the at least one guide element further based on the balanced distribution ratio.

13. The combine of claim 11, wherein the control device is further configured to detect a difference between the distribution of the residual flow of material and a target distribution;
wherein the control device is configured to interpret the indication of the side wind as a disturbance variable; and
wherein the control device is configured to generate the one or more control signals to automatically adjust the position of the at least one guide element based on the disturbance variable and the difference between the distribution of the residual flow and the target distribution.

14. The combine of claim 13, wherein the one or more sensor apparatuses comprise a first sensor apparatus configured to generate one or more first outputs and a second sensor apparatus configured to generate one or more second outputs;
wherein the control device is configured to compare the one or more first outputs with the one or more second outputs in order to determine which of the first sensor apparatus or the second sensor apparatus are sensing greater side wind; and
wherein the control device is configured to generate the one or more control signals to automatically adjust the position of the at least one guide element using respective one or more outputs of the first sensor apparatus or the second sensor apparatus that is sensing the greater side wind.

15. The combine of claim 14, wherein the first sensor apparatus and the second sensor apparatus are positioned at opposite sides of the combine in a same horizontal plane.

16. The combine of claim 15, wherein the first sensor apparatus and the second sensor apparatus each comprise a wind plate positioned on swinging arm.

17. The combine of claim 11, wherein the one or more sensor apparatuses are positioned above the distribution device and below the material delivery region of the axial separator.

18. The combine of claim 11, wherein, for the distribution of the residual flow of material to approach a target distribution, the control device is configured to continuously change a speed of movement of the at least one guide element.

19. The combine of claim 11, wherein the at least one sensor unit is positioned in one or both at at least one measuring point in a supply region of a chopping device downstream from the axial separator or on a floor sectionally enclosing a cutter drum of the chopping device.

20. The combine of claim 11, wherein the at least one sensor unit is configured to detect an axial distribution of the residual flow of material; and
wherein the at least one sensor unit is designed as a measuring strip that has a plurality sensor elements at a distance from each other.
